(19) United States
(12) Patent Application Publication
(10) Pub. No.: US 2023/0080134 A1
(43) Pub. Date: Mar. 16, 2023

(54) A COFFEE-BASED BEVERAGE

(71) Applicant: NATIONAL UNIVERSITY OF SINGAPORE, Singapore (SG)

(72) Inventors: Shao Quan LIU, Singapore (SG); Mei Zhi Alcine CHAN, Singapore (SG); Mingzhan TOH, Singapore (SG)

(73) Assignee: NATIONAL UNIVERSITY OF SINGAPORE, Singapore (SG)

(21) Appl. No.: 17/793,206

(22) PCT Filed: Jan. 15, 2021
(86) PCT No.: PCT/SG2021/050028

§ 371 Date: Jul. 15, 2022

(30) Foreign Application Priority Data
Jan. 16, 2020 (SG) 10202000411V

(51) Int. Cl. A23F 5/24; A23L 33/135

(52) U.S. Cl. CPC A23F 5/246; A23F 5/243; A23L 33/135; A23V 2002/00; A23Y 2220/73; A23Y 2220/63; A23Y 2220/67; A23Y 2220/03; A23Y 2220/35; A23Y 2220/37

(57) ABSTRACT

The invention relates to a coffee-based beverage comprising probiotics, wherein the probiotics has a live probiotic cell count of >6.0 log CFU/mL. The invention further relates to a method of preparing the coffee-based beverage with a live probiotic cell count of >6.0 log CFU/mL, comprising the steps of: mixing coffee brew with sugar and an inactivated yeast to form a mixture, adding probiotics to the mixture to form an inoculated mixture, and fermenting the inoculated mixture for a pre-determined period of time to form the beverage. The probiotics may comprise Lactobacillus rhamnosus, Lactobacillus paracasei, Lactobacillus plantarum, Lactobacillus acidophilus, Lactobacillus gasseri, Lactobacillus fermentum, Bifidobacterium lactis, Saccharomyces boulardii, Saccharomyces cerevisiae, or a combination thereof.

### TECHNICAL FIELD

The present invention relates to a coffee-based beverage and a method of preparing the same.

### BACKGROUND

As consumers get more health conscious, the popularity of functional food and beverages is increasing. These trends have spurred strong innovation in the probiotic foods marketplace, marking the appearance of a plethora of probiotic delivery formats including dairy, cereals, soy, fruits, vegetables, meat.

Coffee is also a largely consumed beverage all over the world. With a consumer's concerns with sugar, and focus towards beverages with fewer perceived additives and natural functionality, there is a need for a functional coffee-based beverage. However, there are challenges in developing a probiotic fermented coffee beverage. First, there is a scarcity of fermentable substrates in coffee brews making it difficult to enable probiotic growth. Excessive addition of nutrients, however, may lead to lactic acid accumulation which produce detrimental effects on sensorial and physicochemical characteristics of coffee.

There is therefore a need for an improved coffee brew which may be considered a functional beverage.

### SUMMARY OF THE INVENTION

The present invention seeks to address these problems, and/or to provide a coffee-based beverage.

According to a first aspect, the present invention provides a coffee-based beverage comprising probiotics, wherein the probiotics has a live probiotic cell count of 6.0 log CFU/mL. In particular, the beverage may be a fermented beverage.

According to a particular aspect, the probiotics comprised in the beverage may have a live probiotic cell count of 6.0 log CFU/mL after 3 months of storage. In particular, the beverage may have a live probiotic cell count of 7.0 log CFU/mL.

The probiotics comprised in the beverage may be any suitable probiotics. In particular, the probiotics may comprise, but is not limited to: a probiotic bacteria, a probiotic yeast, or a combination thereof. According to a particular aspect, the probiotics may comprise: lactic acid bacteria, bifidobacteria, Saccharomyces yeast, non-Saccharomyces yeast, or a combination thereof.

In particular, the lactic acid bacteria may be, but not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, or a combination thereof.

In particular, the Saccharomyces yeast may be, but not limited to: Saccharomyces (S.) boulardii, S. cerevisiae, or a combination thereof.

According to a particular aspect, the probiotics may comprise, but is not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, Saccharomyces (S.) boulardii, S. cerevisiae, or a combination thereof.

The beverage may further comprise an additive. The additive may be any suitable additive. For example, the additive may be, but not limited to, a sweetener, a stabilizer, a flavouring, or a combination thereof.

According to a second aspect, the present invention provides a method of preparing a coffee-based beverage comprising probiotics having a live cell count of 6.0 log CFU/mL, the method comprising:
mixing coffee brew with sugar and an inactivated yeast derivative to form a mixture;
adding probiotics to the mixture to form an inoculated mixture; and
fermenting the inoculated mixture for a pre-determined period of time to form the beverage.

The mixing may comprise mixing a suitable amount of sugar and inactivated yeast derivatives. According to a particular aspect, the mixing may comprise mixing sugar at a concentration of 0.01-10% w/v based on the total volume of the mixture.

According to a particular aspect, the mixing may comprise mixing inactivated yeast derivative at a concentration of 0.005-5% w/v based on total volume of the mixture.

The adding probiotics may comprise adding any suitable probiotics. For example, the probiotics may be as described above in relation to the first aspect of the present invention.

According to a particular aspect, the adding may comprise adding probiotics to obtain an initial probiotic live count of at least 6 log CFU/mL. In particular, the adding may comprise adding probiotics to obtain an initial probiotic live count of at least 7 log CFU/mL.

The fermenting may be for a suitable pre-determined period of time. For example, the pre-determined period of time may be 4-100 hours.

The fermenting may be at a suitable temperature. For example, the fermenting may be at a temperature of 15-45° C.

The method may further comprise adding an additive to the mixture. The additive may be any suitable additive. For example, the additive may be, but not limited to, a sweetener, a stabilizer, a flavouring, or a combination thereof.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows the effect of supplementing different levels of glucose on L. rhamnosus GG growth, at 0%, 0.03%, and 0.3% of (FIG. 1A) Optiwhite®, (FIG. 1B) Optired®, (FIG. 1C) Noblesse® after 24 hours. Different lowercase letters indicate significant differences (P<0.05) between glucose levels at the same IYD level. Initial inoculum ˜7 Log CFU/mL;

FIG. 2 shows the effects of supplementing different IYD types on L. rhamnosus GG growth after 24 hours. Different lowercase letters indicate significant differences (P<0.05) between IYD types at the same IYD level. Initial inoculum ˜7 Log CFU/mL;

FIG. 3 shows the effects of supplementing different levels of (FIG. 3A) Optiwhite®, and (FIG. 3B) Noblesse® on L. rhamnosus GG growth after 24 hours. Different lowercase letters indicate significant differences (P<0.05) between IYD levels. Initial inoculum ˜7 Log CFU/mL;

FIG. 4 shows the effects of supplementing different levels of (FIG. 4A) Optiwhite®, and (FIG. 4B) Noblesse® on pH. Different lowercase letters indicate significant differences (P<0.05) between IYD levels;

FIG. 5 shows growth and survival of L. rhamnosus GG, L. plantarum 299v, L. paracasei Lpc-37, or L. acidophilus NCFM during fermentation and storage in (FIG. 5A) supplemented coffee at 4° C., (FIG. 5B) non-supplemented coffee at 4° C., (FIG. 5C) supplemented coffee at 25° C., (FIG. 5D) non-supplemented coffee at 25° C. Values are the mean of triplicate experiments (n=3), with error bars representing the standard deviation of the mean values;

FIG. 6 shows changes in headspace volatile levels of (FIG. 6A) 3-Methylbutanoic acid, (FIG. 6B) Diacetyl, and (FIG. 6C) Acetoin. Mean values with different lowercase letters indicate statistical differences (P<0.05) between different time points, within the same probiotic strain. # indicates not detected;

FIG. 7 shows growth and survival of single and mixed cultures of (FIG. 7A) L. rhamnosus GG, (FIG. 7B) and S. boulardii CNCM-I745 during fermentation and storage of coffee brews at 4° C. and 25° C. Values are the mean of triplicate experiments (n=3), with error bars representing the standard deviation of the mean values;

FIG. 8 shows changes in selected alkaloids and phenolic compounds during fermentation and storage of coffee brews with single and mixed cultures of L. rhamnosus GG or S. boulardii CNCM-I745—(FIG. 8A) Caffeine, (FIG. 8B) Trigonelline, (FIG. 8C) Caffeic acid, and (FIG. 8D) Chlorogenic acid. Mean values with different lowercase letters indicate statistical differences (P<0.05) between different fermentation setups, within the same time point. *Indicates trace levels;

FIG. 9 shows changes in antioxidant capacities during fermentation and storage of coffee brews with single and mixed cultures of L. rhamnosus GG or S. boulardii CNCM-I745—(FIG. 9A) Total phenolic content, (FIG. 9B) 2,2-diphenyl-1-picrylhydrazyl, and (FIG. 9C) Oxygen radical scavenging assay. Mean values with different lowercase letters indicate statistical differences (P<0.05) between different fermentation setups, within the same time point;

FIG. 10 shows growth and survival at 4° C. of single and mixed cultures of (FIG. 10A) L. plantarum 299v, (FIG. 10B) L. acidophilus NCFM, (FIG. 100) L. fermentum PCC, (FIG. 10D) L. gasseri LAC-343, (FIG. 10E) S. boulardii CNCM-I745. Growth and survival at 25° C. of single and mixed cultures of (FIG. 10F) L. plantarum 299v, (FIG. 10G) L. acidophilus NCFM, (FIG. 10H) L. fermentum PCC, and (FIG. 10I) L. gasseri LAC-343, (FIG. 10J) S. boulardii CNCM-I745. Values are the mean of triplicate experiments (n=3), with error bars representing the standard deviation of the mean values;

FIG. 11 shows pH at 4° C. of single and mixed cultures of (FIG. 11A) L. plantarum 299v, (FIG. 11B) L. acidophilus NCFM, (FIG. 11C) L. fermentum PCC, (FIG. 11D) L. gasseri LAC-343, (FIG. 11E) S. boulardii CNCM-I745. pH at 25° C. of single and mixed cultures of (FIG. 11F) L. plantarum 299v, (FIG. 11G) L. acidophilus NCFM, (FIG. 11H) L. fermentum PCC, and (FIG. 11I) L. gasseri LAC-343, (FIG. 11J) S. boulardii CNCM-I745. Values are the mean of triplicate experiments (n=3), with error bars representing the standard deviation of the mean values;

FIG. 12 shows changes in lactic acid during fermentation and storage of coffee brews with single and mixed cultures of probiotic LAB cultures and S. boulardii CNCM-I745. * Indicates statistical differences (P<0.05) compared to the blank, within the same time point; and

FIG. 13 shows changes in trigonelline, caffeine and chlorogenic acid during fermentation and storage of coffee brews with single and mixed cultures of probiotic LAB and/or S. boulardii CNCM-I745. * Indicates statistical differences (P<0.05) compared to the blank, within the same time point.

### DETAILED DESCRIPTION

As explained above, there is a need for a coffee-based functional beverage. The present invention provides a method of forming a functional coffee-based beverage.

In general terms, the present invention provides a high value-added coffee-based beverage with functional properties. In particular, the present invention provides a coffee-based beverage comprising high probiotics live counts, which may be sustained at suitable temperatures for a period of time, making the beverage feasible for long-term transport or storage. Further, the endogenous coffee bioactive components such as, but not limited to, caffeine, trigonelline, chlorogenic acid, are preserved in the beverage. The beverage of the present invention therefore provides additional therapeutic benefits compared to regular coffee-based beverages.

According to a first aspect, the present invention provides a coffee-based beverage comprising probiotics, wherein the probiotics has a live probiotic cell count of 6.0 log CFU/mL. The live probiotic cell count provided may be the live and active probiotic cell count. The live probiotic cell count provided may be the cell count at the time the beverage is prepared.

The beverage may be a fermented beverage. In particular, the beverage may be a fermented probiotic beverage. For the purposes of the present invention, the term probiotic beverage refers to a beverage comprising live and active vegetative probiotic cells. In particular, the probiotic cells are metabolically active.

For the purposes of the present invention, probiotics may include live and active microorganisms which upon ingestion in certain numbers exert health benefits beyond inherent general nutrition. The health benefits delivered by probiotics may mainly be due to their ability to populate gastrointestinal tract, contributing to establishing a healthy and balanced intestinal microflora.

A suitable amount of probiotics may be comprised in the beverage at any time from the preparation of the beverage and during the shelf-life of the beverage. For example, the probiotics may have a live cell count of ≥5.0 log CFU/mL. According to a particular aspect, the probiotics may have a live cell count of ≥6.0 log CFU/mL, ≥7.0 log CFU/mL. Even more in particular, the probiotics may have a live cell count of ≥8.5 log CFU/mL.

In particular, the probiotics comprised in the beverage may have a live cell count of 5.0-9.0 log CFU/mL, 5.5-8.5 log CFU/mL, 6.0-8.0 log CFU/mL, 6.5-7.5 log CFU/mL, 7.0-7.3 log CFU/mL. Even more in particular, the probiotics comprised in the beverage may have a live cell count of about 6.0-9.0 log CFU/m L.

According to a particular aspect, the beverage may be a stable beverage even after a period of time of storage. For example, the probiotics comprised in the beverage may have a live probiotic cell count of ≥6.0 log CFU/mL even after 3 months of storage. In particular, the live probiotic cell count may be 6.0-9.0 log CFU/mL, 6.5-8.5 log CFU/mL, 7.0-8.0 log CFU/mL, 7.2-7.5 log CFU/mL. Even more in particular, the live probiotic cell count may be 6.0-8.0 log CFU/mL. Accordingly, it can be seen that the beverage may still confer health benefits to the consumer even after a certain period of time following the manufacture of the beverage. Thus, the beverage may have a suitable shelf-life.

The probiotics comprised in the beverage may be any suitable probiotic. For example, the probiotics may be, but not limited to, a probiotic bacteria, a probiotic yeast, or a combination thereof. According to a particular aspect, the probiotics comprised in the beverage may be at least one type of probiotic bacteria. According to another particular aspect, the probiotics comprised in the beverage may be at least one type of probiotic yeast. According to another particular aspect, the probiotics comprised in the beverage may be at least one type of probiotic bacteria and at least one type of probiotic yeast. For example, the probiotics may comprise, but is not limited to, lactic acid bacteria, bifidobacteria, Saccharomyces yeast, non-Saccharomyces yeast, or a combination thereof.

The lactic acid bacteria may be any suitable lactic acid bacteria. For example, the lactic acid bacteria may be, but not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, or a combination thereof. In particular, the lactic acid bacteria may be Lb. rhamnosus GG, Lb. paracasei Lpc-37, Lb. plantarum 299v, Lb. acidophilus NCFM, Lb. gasseri Lac-343, Lb. fermentum PCC, or a combination thereof.

The Saccharomyces yeast may be any suitable Saccharomyces yeast. For example, the Saccharomyces yeast may be, but not limited to: Saccharomyces (S.) boulardii, Saccharomyces (S.) cerevisiae, or a combination thereof. In particular, the Saccharomyces yeast may be, but not limited to: S. boulardii CNCM-I745, S. cerevisiae CNCM I-3856, or a combination thereof.

According to a particular aspect, the probiotics may comprise, but is not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, Saccharomyces (S.) boulardii, Saccharomyces (S.) cerevisiae, or a combination thereof. In particular, the probiotics may comprise, but is not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, or a combination thereof. In particular, the probiotics may be Lb. rhamnosus GG, Lb. paracasei Lpc-37, Lb. plantarum 299v, Lb. acidophilus NCFM, Lb. gasseri Lac-343, Lb. fermentum PCC, B. lactis BB-12, S. boulardii CNCM-I745, S. cerevisiae CNCM I-3856, or a combination thereof.

According to a particular aspect, the probiotics may comprise a combination of Saccharomyces yeast with at least one probiotic bacteria. The probiotic bacteria may be as described above. In particular, the probiotics may comprise a combination of Saccharomyces yeast with at least one of Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, or a combination thereof. For example, the probiotics may comprise a combination of Saccharomyces yeast with at least one of Lb. rhamnosus GG, Lb. paracasei Lpc-37, Lb. plantarum 299v, Lb. acidophilus NCFM, Lb. gasseri Lac-343, Lb. fermentum PCC, B. lactis BB-12. The Saccharomyces yeast may be Saccharomyces (S.) boulardii, Saccharomyces (S.) cerevisiae, or a combination thereof. In particular, the Saccharomyces yeast may be, but not limited to: S. boulardii CNCM-I745, S. cerevisiae CNCM I-3856, or a combination thereof.

The beverage may further comprise an additive. The additive may be any suitable additive. The additive may be any suitable additive for giving a more finished consumer product, for enhancing the flavour profile of the beverage and/or for enhancing the organoleptic properties of the beverage. For example, the additive may be, but not limited to, a sweetener, a stabilizer, a flavouring, or a combination thereof.

According to a second aspect, the present invention provides a method of preparing a coffee-based beverage comprising probiotics having a live cell count of 6.0 log CFU/mL, the method comprising:
mixing coffee brew with probiotic nutrients to form a mixture;
adding probiotics to the mixture to form an inoculated mixture; and
fermenting the inoculated mixture for a pre-determined period of time to form the beverage.

The method may be a method for forming the coffee-based beverage according to the first aspect described above.

The method may be a method for forming a coffee-based beverage comprising probiotics having a live cell count of ≥7.0 log CFU/mL.

The probiotic nutrients may be any suitable nutrients which provide a suitable environment to encourage probiotic cell growth. For example, the probiotic nutrients may comprise, but is not limited to, sugar, inactivated yeast derivatives, yeast extracts, or a combination thereof.

According to a particular aspect, the mixing may comprise mixing coffee brew with sugar and inactivated yeast derivative.

The coffee brew may be any suitable coffee brew.

The inactivated yeast derivative (IYD) may be any suitable IYD. For the purposes of the present invention, a IYD may comprise thermally or enzymatically inactivated yeast extracts. IYD may comprise, but is not limited to, yeast cell walls and yeast autolysates.

The mixing may comprise mixing a suitable amount of inactivated yeast derivative, According to a particular aspect, the mixing may comprise mixing inactivated yeast derivative at a concentration of 0.005-5% w/v based on total volume of the mixture. In particular, the inactivated yeast derivative mixed may be at a concentration of 0.01-5.0% w/v, 0.02-3% w/v, 0.03-2.5% w/v, 0.04-2.0% w/v, 0.05-1.5% w/v, 0.06-1.0% w/v, 0.07-0.9% w/v, 0.08-0.8% w/v, 0.09-0.7% w/v, 0.1-0.6% w/v, 0.2-0.5% w/v, 0.3-0.4% w/v based on the total volume of the mixture. Even more in particular, the inactivated yeast derivative mixed may be at a concentration of 0.03-0.06 vol % based on the total volume of the mixture.

The sugar may be any suitable sugar. For example, the sugar may be a fermentable sugar. According to a particular aspect, the sugar may be glucose.

The mixing may comprise mixing a suitable amount of sugar. According to a particular aspect, the mixing may comprise mixing sugar at a concentration of 0.01-10% w/v based on the total volume of the mixture. In particular, the sugar mixed may be at a concentration of 0.05-9% w/v, 0.1-8% w/v, 0.2-7% w/v, 0.25-6% w/v, 0.3-5% w/v, 0.4-4% w/v, 0.45-3% w/v, 0.5-2% w/v, 0.6-1.0% w/v, 0.7-0.9% w/v, 0.75-0.8% w/v based on the total volume of the mixture. Even more in particular, the glucose mixed may be at a concentration of 0.25-0.5 vol % based on the total volume of the mixture.

According to a particular aspect, the mixing may be by any suitable means. For example, the mixing may comprise stirring the mixture.

The method may further comprise cooling the mixture prior to the adding probiotics. In particular, the cooling may comprise cooling the mixture to ambient temperature, for example about 25° C.

The adding probiotics may comprise adding any suitable probiotics to the mixture. For example, the probiotics may comprise, but not limited to, a probiotic bacteria, a probiotic yeast, or a combination thereof. According to a particular aspect, the probiotics added to the mixture may be at least one type of probiotic bacteria.

According to another particular aspect, the probiotics added to the mixture may be at least one type of probiotic yeast. According to another particular aspect, the probiotics added to the mixture may be at least one type of probiotic bacteria and at least one type of probiotic yeast. For example, the probiotics added may comprise, but is not limited to, lactic acid bacteria, bifidobacteria, Saccharomyces yeast, non-Saccharomyces yeast, or a combination thereof.

The lactic acid bacteria added may be any suitable lactic acid bacteria. For example, the lactic acid bacteria may be, but not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, or a combination thereof. In particular, the lactic acid bacteria may be Lb. rhamnosus GG, Lb. paracasei Lpc-37, Lb. plantarum 299v, Lb. acidophilus NCFM, Lb. gasseri Lac-343, Lb. fermentum PCC, or a combination thereof.

The Saccharomyces yeast added may be any suitable Saccharomyces yeast. For example, the Saccharomyces yeast may be, but not limited to: Saccharomyces (S.) boulardii, Saccharomyces (S.) cerevisiae, or a combination thereof. In particular, the Saccharomyces yeast may be, but not limited to: S. boulardii CNCM-I745, S. cerevisiae CNCM I-3856, or a combination thereof.

According to a particular aspect, the probiotics added may comprise, but is not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, Saccharomyces (S.) boulardii, Saccharomyces (S.) cerevisiae, or a combination thereof. In particular, the probiotics may comprise, but is not limited to: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, or a combination thereof. In particular, the probiotics may be Lb. rhamnosus GG, Lb. paracasei Lpc-37, Lb. plantarum 299v, Lb. acidophilus NCFM, Lb. gasseri Lac-343, Lb. fermentum PCC, B. lactis BB-12, S. boulardii CNCM-I745, S. cerevisiae CNCM I-3856, or a combination thereof.

According to a particular aspect, the probiotics added may comprise a combination of Saccharomyces yeast with at least one probiotic bacteria. The probiotic bacteria may be as described above. In particular, the probiotics added may comprise a combination of Saccharomyces yeast with at least one of Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, or a combination thereof. For example, the probiotics added may comprise a combination of Saccharomyces yeast with at least one of Lb. rhamnosus GG, Lb. paracasei Lpc-37, Lb. plantarum 299v, Lb. acidophilus NCFM, Lb. gasseri Lac-343, Lb. fermentum PCC, B. lactis BB-12. The Saccharomyces yeast may be Saccharomyces (S.) boulardii, Saccharomyces (S.) cerevisiae, or a combination thereof. In particular, the Saccharomyces yeast may be, but not limited to: S. boulardii CNCM-I745, S. cerevisiae CNCM I-3856, or a combination thereof.

When the adding comprises adding a combination of probiotics, the two or more probiotics may be added simultaneously or sequentially into the mixture. According to a particular aspect, the two or more probiotics may be added sequentially. In particular, the adding probiotics may comprise adding a first probiotics to the mixture followed by adding a second or subsequent probiotics after a pre-determined period of time after the addition of the first probiotics.

According to a particular aspect, the two or more probiotics may be added to the mixture simultaneously. In particular, the first and second or subsequent probiotics are all added to the mixture at the same time.

The adding probiotics may comprise adding a suitable amount of probiotics. According to a particular aspect, the adding probiotics may comprise adding probiotics to obtain an initial probiotic live count of at least 1 log CFU/mL. For example, the amount of probiotics added may be at least 4 log CFU/mL. In particular, the amount of probiotics added may be about 5-7 log CFU/mL, 5.5-6.5 log CFU/mL, 5.7-6 log CFU/mL. Even more in particular, the amount of probiotics added may be 4.5-7.0 log CFU/mL.

According to a particular aspect, the adding may comprise adding probiotics to obtain an initial probiotic live count of at least 6 log CFU/mL. In particular, the adding may comprise adding probiotics to obtain an initial probiotic live count of at least 7 log CFU/mL.

The adding probiotics may be under suitable conditions. For example, the adding probiotics may be in an aseptic setup.

The method may further comprise incubating the mixture at a suitable temperature prior to the adding probiotics. In particular, the temperature may be the temperature at which the fermenting will occur. In this way, homogeneous growth of the probiotics may occur in the mixture.

The fermenting may be carried out under any suitable conditions. For example, the fermenting may be for a pre-determined period of time. The pre-determined period of time may be any suitable period of time for the purposes of the present invention. The pre-determined period of time may be dependent on the probiotics added in the adding probiotics. According to a particular aspect, the pre-determined period of time may be 4-100 hours. In particular, the pre-determined period of time may be 4-96 hours, 5-72 hours, 6-60 hours, 12-54 hours, 18-48 hours, 24-42 hours, 30-36 hours. Even more in particular, the pre-determined period of time may be about 12-14 hours.

The fermenting may be at a pre-determined temperature. The pre-determined temperature may be any suitable temperature for the purposes of the present invention. According to a particular aspect, the pre-determined temperature may be 15-45° C. In particular, the pre-determined temperature may be 20-40° C., 25-37° C., 30-35° C. Even more in particular, the pre-determined temperature may be about 30° C. The temperature may be changed at any point during the fermenting.

The method may further comprise adding an additive to the mixture. The additive may be any suitable additive. In particular, the additive may be for enhancing the flavour profile of the beverage and/or for enhancing the organoleptic properties of the beverage. For example, the additive may be, but not limited to, a sweetener, a stabilizer, a flavouring, or a combination thereof.

According to a particular aspect, the formed coffee-based beverage may be stored at a suitable temperature following the fermentation. For example, the beverage may be stored at a temperature of 30° C. In particular, the beverage may be stored at a temperature of about 25° C., 1-25° C., 2-20° C., 4-15° C., 5-12° C., 7-10° C. Even more in particular, the beverage may be stored at a temperature of about 4-25° C.

Having now generally described the invention, the same will be more readily understood through reference to the following embodiment which is provided by way of illustration, and is not intended to be limiting.

### EXAMPLES

### Example 1

The effects of nutrient supplementation on the growth of probiotics in coffee brews was investigated.

In particular, nutrients in the form of glucose and inactivated yeast derivatives were selected for the purposes of this example. In particular, glucose was added as a universal carbon source, providing energy in the form of ATP for probiotic growth. Three different types of inactivated yeast derivatives (IYD) which were used for the purposes of this example were Optiwhite®, Optired®, and Noblesse® (all from Lallemand Pty.), as they supply the medium with peptides, amino acids, vitamins, minerals, and yeast cell wall components that are able to stimulate probiotic growth.

Method

Coffee brews contained within 250-mL glass capped bottles were supplemented with glucose (0%, 0.25%, 0.5%, 1%), and Optiwhite®, Optired®, or Noblesse® (0%, 0.03%, 0.06%, 0.1%, 0.2%, 0.3%, 0.4%, 0.5%, and 0.6%). Supplemented coffee brews were then inoculated with GG (Chr. Hansen A/S) (˜7 Log CFU/mL), followed by distribution of 40 mL aliquots into 50-mL propylene centrifuge tubes. Fermentation then proceeded at 30° C. for 24 h, which was carried out in triplicates.

Results

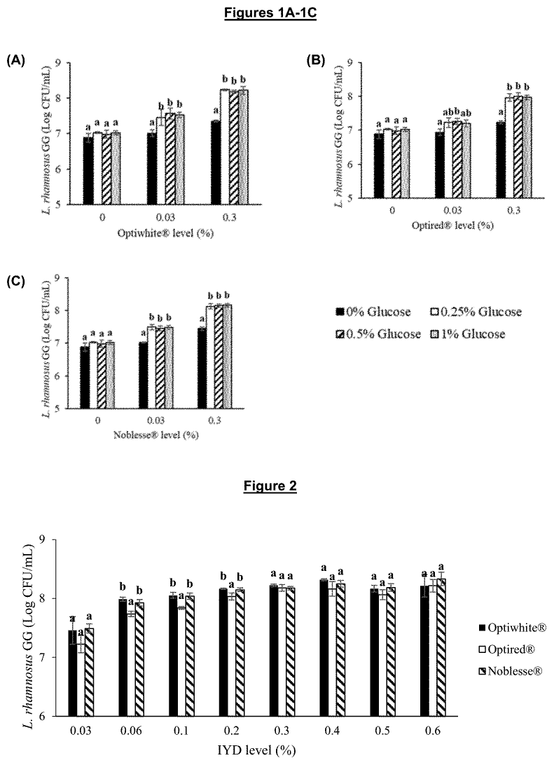

FIG. 1 shows the effect of different levels of glucose on the growth of GG. In non-supplemented coffees (0% glucose, 0% IYD), there was an absence of probiotic growth (initial inoculum ˜7 Log CFU/mL). Increasing glucose levels at an IYD level of 0% did not result in significant increases in probiotic growth. However, once IYD was present (0.03% or 0.3% Optiwhite®, Optired®, or Noblesse®), the addition of glucose (0.25%, 0.5%, and 1%) resulted in significant increases in probiotic biomass. The results suggest that the presence of both glucose and IYDs are required to enable probiotic growth, reaffirming the scarcity of fermentable substrates in coffee brews, and the necessity of nutrient supplementation.

It was also observed that in the presence of IYDs (0.03% or 0.3% Optiwhite®, Optired®, or Noblesse®), increasing glucose levels beyond 0.25% did not result in further significant increases in probiotic growth. Therefore, this level of glucose supplementation was utilized in subsequent examples below.

The effects of three different IYD types (Optiwhite®, Optired®, or Noblesse®) on GG growth after 24 h of fermentation were examined. The results are as shown in FIG. 2.

At IYD concentrations of 0.03%, and 0.3-0.6%, no significant differences in GG cell counts were observed. However, at IYD levels of 0.06%, 0.1%, and 0.2%, coffee brews supplemented with Optired® displayed significantly lower probiotic cell counts compared to Optiwhite® and Noblesse®. On the basis of achieving maximum probiotic biomass with the least degree of nutrient supplementation, Optired® was thus eliminated in subsequent trials. Subsequently, the effect of supplementing different levels of Optiwhite® and Noblesse® on the growth of L. rhamnosus GG and pH levels was investigated.

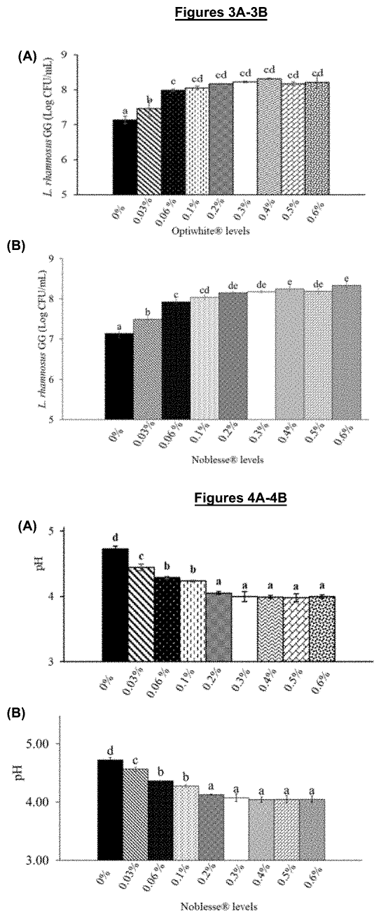

Since Optiwhite® and Noblesse® enhanced the growth of L. rhamnosus GG to similar extents in FIG. 2, their levels were varied in FIGS. 3 and 4, in an attempt to identify the minimum level of Optiwhite®/Noblesse® required for maximal L. rhamnosus GG growth. As can be seen in FIG. 3, for Optiwhite®, significant increases in probiotic biomass were observed when supplementation increased from 0% to 0.06%, reaching a final cell count of 7.99 Log CFU/mL (0.85 Log increase). Further additions of Optiwhite® did not result in further significant increases in biomass. For Noblesse®, probiotic cell counts significantly increased to 8.15 Log CFU/mL (1.1 Log increase) as dosage levels increased from 0%, to 0.2%. Beyond 0.2% of Optired® supplementation, further increases in cell counts were not observed.

An Optiwhite® dosage level of 0.06% may be favourable compared to using a higher dosage of 0.2% Noblesse® due to savings in raw material costs. In addition, it was observed visually that sedimentation in supplemented coffee brews increased as IYD dosages increased, which might impart undesirable sensorial impacts. Furthermore, the end pH obtained with 0.06% of Optiwhite (pH 4.29) was significantly higher compared to the pH obtained with 0.2% Noblesse® (pH 4.13; FIG. 4). A higher final pH may impose a lesser degree of acid stress on probiotics, thus preventing probiotic viability losses during product storage. Therefore, for practical and sensorial reasons, a final Optiwhite® supplementation level of 0.06% was chosen for the subsequent examples.

### Example 2

The effect of fermentation with single cultures of probiotic cultures was investigated.

In particular, using a coffee brew formulation of 0.25% glucose and 0.06% Optiwhite®, this example assessed the growth and survival of four different probiotic strains during fermentation and storage. This was with the aim of identifying the probiotic bacteria strain that could survive for the longest period of time (>7 Log CFU per mL) during storage of the probiotic fermented coffee brews.

Method

Probiotic growth in non-supplemented coffee brews, and their supplemented counterparts (0.25% (w/v) glucose, 0.06% (w/v) Optiwhite®), were assessed over a 24 h fermentation period. Probiotic survival was then monitored during storage at 4° C. and 25° C. To achieve this, single probiotic bacteria cultures of L. rhamnosus GG (GG), L. acidophilus NCFM (NCFM) (Danisco A/S), L. plantarum 299v (299v) (Probi AB), or L. paracasei Lpc-37 (Lpc37) (Danisco A/S) were first inoculated into either supplemented (S-) or non-supplemented (N-) coffee brews, contained within 250-mL glass capped bottles. Initial inoculum sizes were standardized to about 7 Log CFU/mL. Aliquots of 40 mL or 12 mL of inoculated coffees were then distributed into 50-mL or 15-mL polypropylene centrifuge tubes respectively. Triplicate batches were then fermented at 30° C. for 24 h, followed by storage at 4° C. and 25° C.

Results

L. rhamnosus GG and L. paracasei Lpc-37 exhibited the best survival during storage, and were subjected to further volatile and non-volatile analyses. Analyses timepoints were: 0 h, 24 h, 2 weeks at 25° C., and 10 weeks at 4° C., corresponding to the end shelf life criterion (7 Log CFU/mL). Analytical measurements include volatile and non-volatile measurements (sugar, organic acid, amino acid, phenolic compounds, alkaloids), and antioxidant capacity assays in the form of total phenolic content (TPC), 2,2-diphenyl-1-picrylhydrazyl (DPPH), and Oxygen Radical Absorbance Capacity (ORAC).

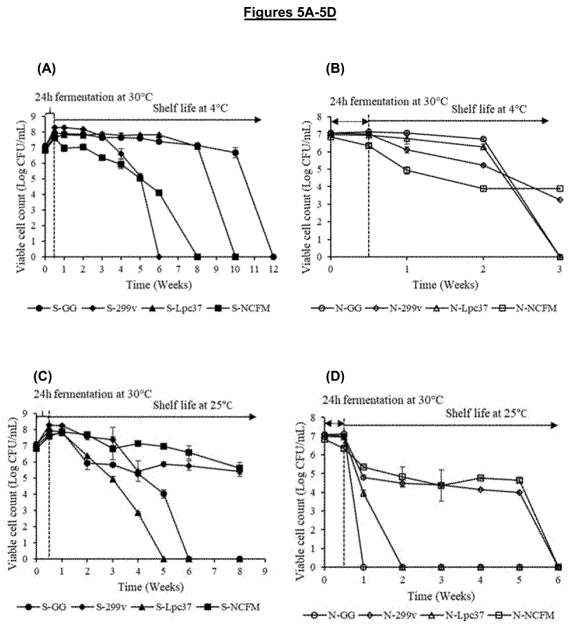

FIG. 5 shows the growth and survival of individual probiotic strains in non-supplemented (N-), and supplemented (S-) coffee brews. In non-supplemented coffees, all four probiotic strains did not exhibit growth. On the other hand, significant increases in probiotic biomass were observed in supplemented coffees, with L. rhamnosus GG (S-GG), L. plantarum 299v (S-299v), L. paracasei Lpc-37 (S-Lpc37), and L. acidophilus NCFM (S-NCFM) reaching stationary phase cell counts of 7.93, 8.28, 7.67, and 7.58 Log CFU/mL after 24 h respectively.

Upon storage, probiotic viable cell counts were maintained above 7 Log CFU/mL for significantly longer periods of time in supplemented coffee brews compared to their non-supplemented counterparts. In non-supplemented coffees, viable cell counts of all four probiotic strains fell below the benchmark within a week of storage at either temperature. An exception was L. rhamnosus GG, which displayed cell counts above the benchmark up to 2 weeks of storage at 4° C. In supplemented coffee brews, viable cell counts of L. rhamnosus GG and L. paracasei Lpc-37 fell below 7 Log CFU/mL within 2 and 10 weeks of storage at 25° C. and 4° C. respectively. Shelf life was 4 and 3 weeks for L. plantarum 299v and L. acidophilus NCFM fermented coffee brews respectively at either temperature. The results stress the need for nutrient supplementation in brewed coffee to support both probiotic growth and survival.

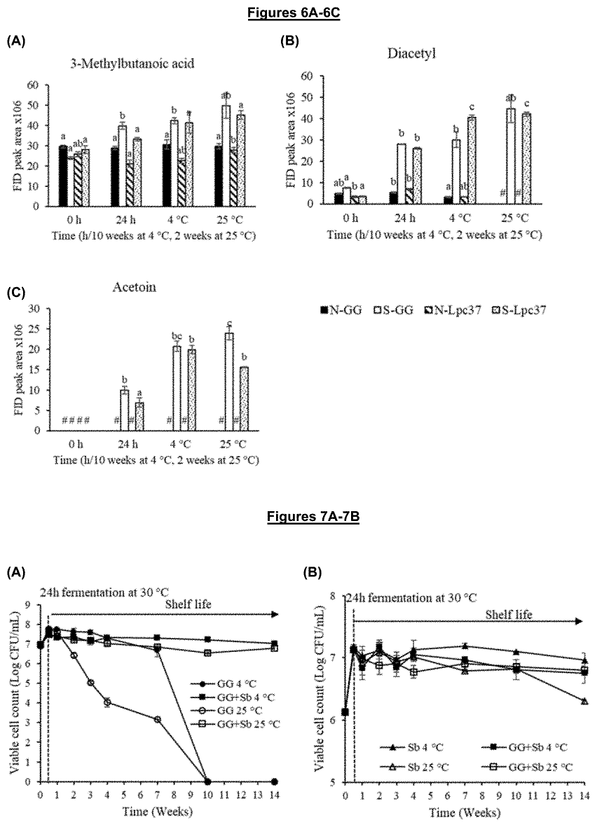

Table 1 shows the changes in non-volatile components (pH, glucose, lactic acid, alanine and glutamic acid), while FIG. 6 show changes in headspace levels of diacetyl, acetoin, and 3-methylbutanoic acid during fermentation and storage period of coffee brews.

In Table 1, mean values in the same row with different lowercase letters indicate statistical differences (P<0.05) between coffees with different supplementation status, within the same probiotic strain, mean values in the same row with different uppercase letters indicate statistical differences (P<0.05) between L. rhamnosus GG and L. paracasei Lpc-37 fermented supplemented coffees. Further, analyses timepoints were: 0 h, 24 h, 2 weeks at 25° C., and 10 weeks at 4° C., corresponding to the end shelf life criterion (7 Log CFU/mL). Initially, non-supplemented coffee brews were devoid of glucose and free amino acids, reinforcing the scarcity of nutrients in coffee brews.

TABLE 1
pH, glucose, lactic acid, glutamic acid, and alanine compositions of non-supplemented and supplemented
coffees during 24 h fermentation and storage at 4° C. and 25° C. with GG or L. paracasei Lpc-37

| | Time (h)/End | | Coffee brew formulations | | | |
|---|---|---|---|---|---|---|
| Parameter | shelf life (° C.) | | N-GG | S-GG | N-Lpc37 | S-Lpc37 |
| pH | 0 | h | 4.80 ± 0.01a | 4.82 ± 0.01aA | 4.79 ± 0.04a | 4.82 ± 0.01aA |
| | 24 | h | 4.80 ± 0.03b | 4.23 ± 0.02aA | 4.77 ± 0.02b | 4.30 ± 0.03aB |
| | 4° | C. | 4.77 ± 0.09b | 3.95 ± 0.03aB | 4.84 ± 0.03b | 3.86 ± 0.01aA |
| | 25° | C. | 4.72 ± 0.00b | 3.72 ± 0.01aA | 4.82 ± 0.02b | 3.81 ± 0.01aB |
| Glucose | 0 | h | ND | 220.85 ± 4.15 | ND | 2.27 ± 0.03 |
| (mg/100 mL) | 24 | h | ND | 146.41 ± 1.98A | ND | 185.94 ± 15.03B |
| | 4° | C. | ND | Trace | ND | ND |
| | 25° | C. | ND | ND | ND | ND |
| Lactic acid | 0 | h | 26.63 ± 3.22a | 24.81 ± 1.49aB | 15.58 ± 0.54a | 16.89 ± 0.33aA |
| (mg/100 mL) | 24 | h | 42.04 ± 2.38a | 149.43 ± 5.44bB | 30.19 ± 0.98a | 122.15 ± 8.85bA |
| | 4° | C. | 38.27 ± 2.57a | 249.33 ± 20.34bA | 29.72 ± 0.84a | 294.20 ± 16.13bB |
| | 25° | C. | 37.30 ± 3.87a | 318.36 ± 16.68bA | 30.53 ± 0.46a | 327.62 ± 12.89bA |
| Glutamic acid | 0 | h | ND | 10.48 ± 0.44A | ND | 9.98 ± 0.51A |
| (mg/L) | 24 | h | ND | 10.19 ± 0.37A | 0.76 ± 0.07a | 11.31 ± 0.17bB |
| | 4° | C. | ND | 6.26 ± 0.48A | 1.14 ± 0.19a | 7.57 ± 0.49bB |
| | 25° | C. | ND | 4.89 ± 0.77A | 1.52 ± 0.03a | 10.62 ± 0.50bB |
| Alanine | 0 | h | ND | 4.43 ± 0.09B | ND | 3.11 ± 0.22A |
| (mg/L) | 24 | h | 0.37 ± 0.01a | 3.58 ± 0.10bA | 0.51 ± 0.04a | 4.08 ± 0.10bB |
| | 4° | C. | 0.31 ± 0.05a | 3.30 ± 0.11bA | 0.46 ± 0.06a | 3.32 ± 0.07bA |
| | 25° | C. | 0.40 ± 0.02a | 3.02 ± 0.15bA | 0.56 ± 0.04a | 3.83 ± 0.13bB |

ND: Not detected.
N, non-supplemented coffee;
S, supplemented coffee;
GG, coffee fermented with GG;
Lpc37, coffee fermented with L. paracasei Lpc-37

For supplemented coffee brews, the provision of nutrients in the form of glucose and Optiwhite® (especially glutamic acid) provided substrates for growth of probiotic bacteria. Glucose, alanine, and glutamic acid were progressively utilized by L. rhamnosus GG and L. paracasei Lpc-37 throughout fermentation and storage. As a result of growth, concomitant productions of bacterial metabolites were observed (lactic acid, diacetyl, acetoin, 3-methylbutanoic acid). During fermentation, lactic acid production corresponded with significant declines in pH, which further declined during the course of storage, attributed to continual utilisation of glucose. Besides lactic acid, bacterial volatile metabolites were also produced (FIG. 6), with significant increases in levels of 3-methylbutanoic acid, diacetyl, and acetoin during fermentation and storage.

The production of these bacterial metabolites may result in flavour changes and different taste profiles compared to regular coffee brews. For example, lactic acid imparts sour notes, 3-methylbutanoic acid imparts cheesy, sweaty odours (depending on the concentration), while diacetyl and acetoin impart buttery aromas.

Levels of chlorogenic acid, alkaloids, and antioxidant capacities of coffee brews are shown in Table 2. Efforts were made to analyse alkaloids and phenolic endogenous to coffees, since they are commonly associated with the therapeutic benefits of coffee consumption. In general, levels of bioactive components as well as overall antioxidant capacities of the coffee brews were unaffected by nutrient supplementation, probiotic bacterial fermentation or during storage. These results suggest that original coffee therapeutic benefits might be retained in probiotic coffees. In Table 2, mean values in the same row with different lowercase letters indicate statistical differences (P<0.05) between coffees with different supplementation status, within the same probiotic strain. Mean values in the same row with different uppercase letters indicate statistical differences (P<0.05) between L. rhamnosus GG and L. paracasei Lpc-37 fermented supplemented coffees.

TABLE 2
Chlorogenic acid, trigonelline, caffeine, and antioxidant capacities of non-supplemented and supplemented
coffees during 24 h fermentation and storage at 4° C. and 25° C. with GG or L. paracasei Lpc-37

| | Time (h)/End | | Coffee brew formulations | | | |
|---|---|---|---|---|---|---|
| Parameter | shelf life (° C.) | | N-GG | S-GG | N-Lpc37 | S-Lpc37 |
| Bioactive components | | | | | | |
| Chlorogenic acid | 0 | h | 60.68 ± 0.42a | 59.31 ± 1.96aB | 52.81 ± 1.01a | 53.13 ± 0.96aA |
| (5-CQA; mg/100 mL) | 24 | h | 60.19 ± 2.02a | 58.32 ± 1.79aA | 53.82 ± 1.58a | 53.68 ± 3.33aA |
| | 4° | C. | 60.81 ± 4.22a | 57.66 ± 2.11aA | 55.30 ± 1.50a | 55.74 ± 1.38aA |
| | 25° | C. | 54.80 ± 3.75a | 54.22 ± 3.36aA | 52.58 ± 1.76a | 53.47 ± 1.04aA |
| Trigonelline | 0 | h | 51.47 ± 0.61a | 50.88 ± 1.82aA | 48.36 ± 1.09a | 48.57 ± 0.37aA |
| | 24 | h | 52.66 ± 1.96a | 49.81 ± 1.21aA | 49.04 ± 1.38a | 48.24 ± 2.20aA |
| | 4° | C. | 51.19 ± 2.80a | 49.38 ± 0.94aA | 50.21 ± 1.54a | 50.05 ± 1.81aA |
| | 25° | C. | 48.43 ± 3.35a | 48.15 ± 1.73aA | 48.25 ± 1.09a | 49.12 ± 0.87aA |
| Caffeine | 0 | h | 48.25 ± 0.08a | 47.12 ± 1.35aA | 45.85 ± 1.00a | 46.17 ± 0.44aA |
| | 24 | h | 47.86 ± 1.26a | 46.60 ± 1.14aA | 46.79 ± 1.37a | 47.02 ± 2.72aA |
| | 4° | C. | 48.42 ± 3.29a | 46.53 ± 1.63aA | 48.51 ± 1.47a | 49.10 ± 1.40aA |
| | 25° | C. | 45.76 ± 4.56a | 45.36 ± 1.36aA | 46.33 ± 1.39a | 47.23 ± 0.82aA |
| Antioxidant capacity assays | | | | | | |
| TPC (mg Gallic | 0 | h | 1.94 ± 0.03a | 1.82 ± 0.15aA | 1.84 ± 0.14a | 1.90 ± 0.09aA |
| acid equivalent/mL) | 24 | h | 2.02 ± 0.20a | 1.87 ± 0.15aA | 1.89 ± 0.10a | 1.88 ± 0.04aA |
| | 4° | C. | 2.06 ± 0.15a | 1.92 ± 0.20aA | 1.89 ± 0.07a | 1.84 ± 0.04aA |
| | 25° | C. | 1.67 ± 0.05a | 1.79 ± 0.04bA | 1.94 ± 0.06a | 1.80 ± 0.07aA |
| DPPH (mg Trolox | 0 | h | 2.45 ± 0.31a | 2.49 ± 0.21aA | 2.50 ± 0.24a | 2.40 ± 0.18aA |
| equivalent/mL) | 24 | h | 2.59 ± 0.06a | 2.45 ± 0.27aA | 2.33 ± 0.20a | 2.45 ± 0.15aA |
| | 4° | C. | 2.47 ± 0.23a | 2.21 ± 0.31aA | 2.35 ± 0.34a | 2.13 ± 0.27aA |
| | 25° | C. | 2.49 ± 0.30a | 2.14 ± 0.16aA | 2.30 ± 0.24a | 1.96 ± 0.20aA |
| ORAC (mg Trolox | 0 | h | 10.52 ± 1.36a | 11.61 ± 0.87aA | 11.53 ± 1.88a | 9.76 ± 1.11aA |
| equivalent/mL) | 24 | h | 11.63 ± 1.44a | 13.58 ± 1.06aA | 13.40 ± 2.31a | 12.51 ± 0.77aA |
| | 4° | C. | 10.61 ± 0.23a | 12.29 ± 1.26aA | 10.21 ± 1.49a | 11.39 ± 1.33aA |
| | 25° | C. | 10.11 ± 0.04a | 10.99 ± 1.83aA | 10.62 ± 0.70a | 10.09 ± 0.02aA |

ND: Not detected

### Example 3

The effect of fermentation with single and co-cultures of probiotic cultures was investigated.

L. rhamnosus GG demonstrated excellent growth and survival in coffee brews supplemented with 0.25% glucose and 0.06% Optiwhite®. A 0.8 Log increase in cell biomass was observed, which was maintained above 7 Log CFU/mL for 10 weeks under refrigeration, and 2 weeks under ambient temperatures. While a refrigerated shelf life of 10 weeks is reasonable, a cold chain distribution is not only costly, but limits distribution to wider markets, especially in rural regions lacking proper cold chain systems. The lack of commercial viability for products with a short ambient shelf life span necessitates exploring strategies to extend probiotic survival beyond 2 weeks at ambient temperatures.

Therefore, the potential of yeast used as a co-culture with L. rhamnosus GG was investigated to see if it may further enhance the shelf life of probiotic fermented coffee brews. The viability of L. rhamnosus GG in coffee brews by co-culturing with the probiotic yeast, S. boulardii CNCM-I745 was investigated in this example.

Method

Four different fermentation setups were prepared: single culture L. rhamnosus GG (GG), single culture of S. boulardii CNCM-I745 (Sb), mixed cultures of the probiotic bacteria and yeast (GG+Sb), and a control (Blank). The latter consisted of coffee brews without probiotic inoculation. For the former three fermentation setups, inoculation was conducted in 200 mL of coffee brews contained within 250-mL glass capped bottles, with inoculum sizes standardised to ˜7 Log CFU/mL for L. rhamnosus GG, and ˜6 Log CFU/mL for S. boulardii CNCM-I745.

Aliquots of 40 mL or 12 mL of inoculated coffees were then distributed into 50-mL or 15-mL polypropylene centrifuge tubes respectively. Tubes were then kept at 30° C. for 24 h during the fermentation period, and subsequently at either 25° C. or 4° C. during the storage period. Unfermented and fermented coffee brews, as well as samples stored after one month at both temperatures were subjected to further analyses (non-volatile and volatile measurements, and antioxidant capacity assays). All fermentations were conducted in triplicate batches.

Results

FIG. 7 shows the growth of single and mixed cultures of L. rhamnosus GG and S. boulardii CNCM-I745 during fermentation in coffee brews and subsequent storage at 4° C. and 25° C. From an initial cell count of 6.9 Log CFU/mL, L. rhamnosus GG grew to 7.8 and 7.5 Log CFU/mL in single (GG) and mixed cultures (GG+Sb) respectively after 24 h of fermentation. During the same period, S. boulardii CNCM-I745 cell counts increased to 7.1 and 7.2 Log CFU/mL in single (Sb) and mixed cultures (GG+Sb) respectively, from an initial value of 6.1 Log CFU/mL. When probiotic cell counts in single cultures were compared to those in mixed cultures, no significant difference was observed for S. boulardii CNCM-I745, but a significant difference was detected for L. rhamnosus GG. However, it is recognised that growth of L. rhamnosus GG was still satisfactory, as numbers were beyond 7 Log CFU/mL.

During storage, viability of L. rhamnosus GG declined at a much faster rate in single culture compared to the mixed culture. At 4° C., L. rhamnosus GG in single culture was no longer detected within 10 weeks, while a high biomass of 7 Log CFU/mL was maintained after 14 weeks of storage in the mixed culture. At 25° C., cell counts of L. rhamnosus GG in single culture fell below 6 Log CFU/mL within 3 weeks of storage, and were no longer detectable within 10 weeks. On the other hand, viability of the same probiotic strain in mixed culture registered exceedingly high survival rates of 6.8 Log CFU/mL after 14 weeks of ambient storage. Therefore, the survival of L. rhamnosus GG was significantly enhanced by the yeast at ambient and chilled temperatures.

S. boulardii CNCM-I745 proved to be more robust than L. rhamnosus GG during storage. Viable cell counts of the probiotic yeast in both single and mixed cultures were maintained above 6 Log CFU/mL during 14 weeks of storage at 4° C. and 25° C. Interestingly, by week 14 of ambient storage, significantly lower live counts of the probiotic yeast (˜0.5 Log difference) were detected in the single culture compared to the mixed culture. This may indicate that the survival of S. boulardii CNCM-I745 could also be favourably enhanced by L. rhamnosus GG, although an extended period of storage could demonstrate the viability enhancing effect of the probiotic bacteria.

Changes in pH, and non-volatile components during the fermentation and storage periods are shown in Table 3.

TABLE 3
pH, glucose, lactic acid, and citric acid compositions of supplemented coffees
during 24 h fermentation and storage at 4° C. and 25° C. with single
and mixed cultures of L. rhamnosus GG and S. boulardii CNCM-I745

| | Time (h)/End | | Coffee brew formulations | | | |
|---|---|---|---|---|---|---|
| Parameter | shelf life (° C.) | | GG | GGF | F | Blank |
| pH | 0 | h | 4.98 ± 0.05a | 4.97 ± 0.02a | 4.99 ± 0.01a | 4.95 ± 0.00a |
| | 24 | h | 4.28 ± 0.04a | 4.54 ± 0.11b | 4.85 ± 0.01c | 4.87 ± 0.07c |
| | 4° | C. | 4.00 ± 0.05a | 4.56 ± 0.04b | 4.84 ± 0.03c | 4.87 ± 0.01c |
| | 25° | C. | 3.80 ± 0.04a | 4.64 ± 0.06b | 4.88 ± 0.04c | 4.75 ± 0.01c |
| Glucose | 0 | h | 186.97 ± 20.46a | 186.43 ± 18.77a | 188.56 ± 16.79a | 177.89 ± 4.50a |
| (mg/100 mL) | 24 | h | 103.22 ± 8.06a | ND | ND | 187.44 ± 15.41b |
| | 4° | C. | 66.10 ± 8.20a | ND | ND | 181.63 ± 8.01b |
| | 25° | C. | ND | ND | ND | 167.75 ± 11.64 |
| Lactic acid | 0 | h | Trace | Trace | Trace | Trace |
| (mg/100 mL) | 24 | h | 137.87 ± 3.79b | 79.46 ± 4.37a | Trace | Trace |
| | 4° | C. | 192.44 ± 21.39b | 80.66 ± 3.67a | Trace | Trace |
| | 25° | C. | 279.90 ± 6.22b | 79.54 ± 2.65a | Trace | Trace |
| Citric acid | 0 | h | 27.91 ± 2.52a | 30.21 ± 1.81a | 29.06 ± 0.97a | 28.75 ± 2.86a |
| (mg/100 mL) | 24 | h | 28.71 ± 1.52a | 26.90 ± 1.41a | 27.50 ± 2.58 | 27.88 ± 2.43 |
| | 4° | C. | 26.87 ± 1.42a | 26.25 ± 0.27a | 27.28 ± 0.87a | 27.35 ± 1.72a |
| | 25° | C. | 27.10 ± 1.87a | ND | ND | 19.95 ± 2.39a |

ND: Not detected.
Mean values in the same row with different lowercase letters indicate statistical differences (P < 0.05) between different fermentation setups, within the same time point. Analyses timepoints were: 0 h, 24 h, 4 weeks at 25° C. and 4° C.

During fermentation, glucose was completely utilised for coffee brews containing S. boulardii CNCM-I745. On the other hand, utilisation was more gradual for single cultures of L. rhamnosus GG, with 45% of original levels remaining after fermentation. Glucose consumption by the probiotic LAB coincided with significant increases in lactic acid and corresponding significant declines in pH. During storage, pH further declined for coffee brews fermented by single cultures of L. rhamnosus GG, attributed to uptake of residual glucose by the probiotic bacteria.

Although lactic acid was also produced by L. rhamnosus GG in the mixed culture, yields were significantly lower, which resulted in significantly higher pH compared to the single culture. This could be attributed to competition for glucose by the yeast, which limited the amount of glucose available for lactic acid production by L. rhamnosus GG. During storage, no further production in lactic acid was observed in the mixed culture, due to the absence of glucose available for lactic acid production.

For coffee brews containing S. boulardii CNCM-I745, pH remained relatively constant throughout 14 weeks of cold storage. Intriguingly, at ambient temperatures, pH gradually increased during storage, with the effect more pronounced for mixed cultured coffee brews. In the mixed culture, pH steadily climbed from 4.54, to 4.64 after 4 weeks, reaching a value of 4.97 after 14 weeks. Deacidification of coffee brews by S. boulardii could be attributed to the consumption of citric acid by the yeast, which presumably served as an alternative carbon source to support yeast survival during storage.

Deacidification of coffee brews by S. boulardii CNCM-I745, either through citric acid consumption of limiting lactic acid production, could have alleviated acid stress, and therefore enhanced L. rhamnosus GG survival in the mixed culture compared to the single culture. In addition, it is worth mentioning that the prevention of post-acidification by the yeast could be organoleptically favourable.

Table 4 displays selected headspace volatile classes detected in coffee brews after fermentation at 30° C. L. rhamnosus GG was mainly responsible for the release of diacetyl and acetoin, while S. boulardii CNCM-I745 mainly produced alcohols, esters, and phenolic compounds. Each volatile compound imparts unique aromas, for example, higher alcohols and esters impart floral and fruity aromas respectively.

Therefore, coffee brews fermented by different strains of probiotics may result in different flavours.

TABLE 4
Selected headspace volatiles of coffee brews after 24 h fermentation
with single and mixed cultures of GG and S. boulardii CNCM-I745

| | Concentration (ppb) | | | |
|---|---|---|---|---|
| Compound identified | GG | GG + Sb | Sb | Blank |
| 3-Methylbutanoic acid | 29.61 ± 1.79a | 23.42 ± 3.55a | 27.6 ± 2.38a | 26.31 ± 3.04a |
| Octanoic acid | ND | 5.11 ± 0.37 | ND | ND |
| Ethanol | ND | 72.38 ± 7.66a | 130.8 ± 17.67b | ND |
| 3-Methyl-1-butanol | ND | ND | 28.4 ± 4.57 | ND |
| Phenylethyl Alcohol | 1.46 ± 0.26a | 4.93 ± 0.28b | 9.73 ± 1.35c | ND |
| Isoamyl acetate | ND | 0.65 ± 0.04 | ND | ND |
| Ethyl octanoate | ND | ND | 1.72 ± 0.31 | ND |
| Isoamyl octanoate | ND | 1.95 ± 0.46 | ND | ND |
| Ethyl decanoate | ND | 0.65 ± 0.10b | 0.47 ± 0.03a | ND |
| 2,3-Butanedione | 80.54 ± 15.94b | 1.24 ± 0.07a | ND | 5.51 ± 1.03a |
| Acetoin | 5.62 ± 0.64b | 2.15 ± 0.24a | ND | ND |
| Total acids | 98.94 ± 1.35c | 81.46 ± 11.33b | 38.12 ± 3.45a | 111.76 ± 2.67c |
| Total alcohols | 4.88 ± 0.29a | 89.43 ± 8.22b | 171.10 ± 23.19c | ND |
| Total esters | 5.70 ± 0.87a | 4.43 ± 0.52a | 3.98 ± 0.43a | 4.21 ± 0.84a |
| Total ketones | 111.51 ± 20.73c | 3.58 ± 0.34a | 0.34 ± 0.06a | 38.64 ± 7.14b |
| Total volatile phenols | 6.80 ± 0.49a | 16.86 ± 1.61b | 18.74 ± 1.62b | 7.01 ± 0.90a |
| Total terpenes | 25.49 ± 2.30b | 8.17 ± 0.17a | 6.92 ± 0.50a | 29.07 ± 2.27b |
| and terpenoids | | | | |
| Total furans | 463.12 ± 43.47b | 265.14 ± 19.49a | 351.92 ± 23.99a | 545.68 ± 56.90b |
| Total pyrazines | 201.73 ± 8.08a | 212.30 ± 19.07ab | 262.55 ± 25.00b | 232.77 ± 20.59ab |
| Total pyridines | 0.30 ± 0.05a | 1.79 ± 0.30a | 10.36 ± 1.47b | 7.76 ± 1.66b |
| Total pyrroles | 22.81 ± 0.98a | 22.87 ± 1.04a | 30.96 ± 3.73b | 25.99 ± 0.82ab |
| Total sulfur | 2.77 ± 0.25b | 1.83 ± 0.16a | 1.80 ± 0.33a | 3.69 ± 0.23c |
| containing compounds | | | | |
| Total | 946.89 ± 76.61b | 713.9 ± 59.18a | 908.34 ± 78.64ab | 1014.76 ± 89.26b |

ND: Not detected.
Mean values in the same row with different lowercase letters indicate statistical differences (P < 0.05) between coffee brews with different fermentation setups

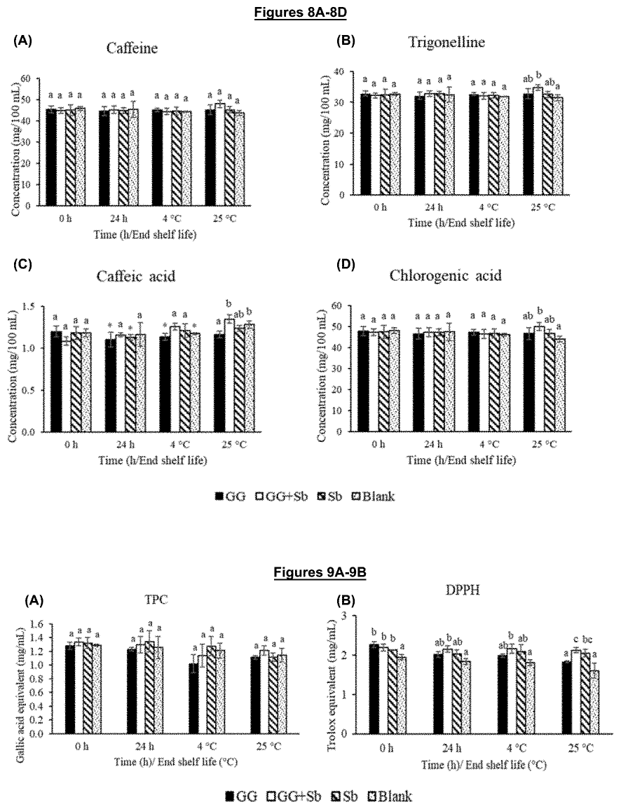

FIG. 8 shows the changes in coffee bioactive components after fermentation and storage. In general, levels of measured alkaloids (caffeine, trigonelline) and phenolic compounds (chlorogenic acid, caffeic acid) remained unchanged. Although levels of trigonelline and chlorogenic acid were detected in significantly higher levels in the mixed culture than the blank after ambient storage, these changes were slight, and may not be practically meaningful. The preservation of endogenous coffee bioactive constituents after fermentation and storage is desirable, since they are commonly cited as potent bioactive coffee components with the propensity to impart physiological benefits.

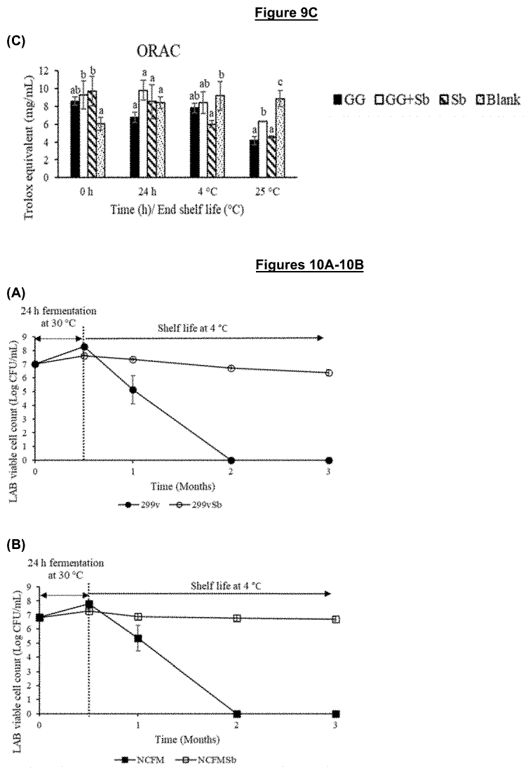

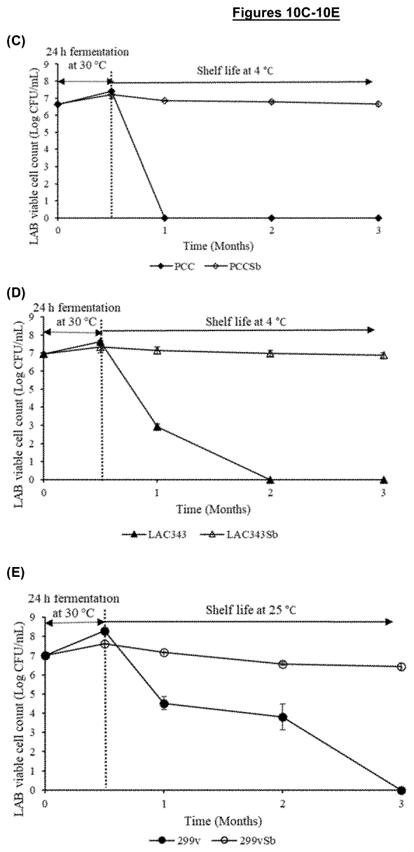

FIG. 9 shows the changes in antioxidant capacities after fermentation and storage of coffee brews. For the TPC assay, there were insignificant changes between coffee brews, regardless of time point. For the DPPH assay, the mixed cultured coffee brew consistently displayed slight but significantly higher antioxidant activities compared to the blank. Although significant, differences were slight, which may not be practically meaningful. From the ORAC assay, Trolox equivalent values were significantly lower in probiotic coffee brews after ambient storage compared to the blank, indicating a loss in peroxyl radical scavenging abilities.

### Example 4

The effect of fermentation of probiotic cultures co-cultured with S. boulardii CNCM-I745 was investigated.

Survival of L. rhamnosus GG was greatly improved when co-cultured with S. boulardii CNCM-I745 in Section 3. However, it would be of further interest to determine if similar effects can be observed by co-culturing S. boulardii CNCM-I745 with other probiotic strains. This is especially relevant, since different probiotic strains exert different physiological benefits upon consumption. In addition, it is of interest to identify compatible probiotic-yeast pairings, since probiotic viability enhancing effects conferred by yeasts are strain dependent, and co-culturing yeasts with probiotic LAB may not necessarily enhance the survival of the latter.

Hence, this example is aimed to examine the effects of co-culturing S. boulardii CNCM-I745 on the growth and survival of L. plantarum 299v, L. acidophilus NCFM, L. fermentum PCC, and L. gasseri LAC-343.

Method

Coffee brews supplemented with 0.25% glucose and 0.06% Optiwhite® were fermented with single cultures of probiotics, L. plantarum 299v (299v), L. acidophilus NCFM (NCFM), L. fermentum PCC (PCC) ( )Chr. Hansen A/S), L. gasseri LAC-343 (LAC343) (Morinaga), S. boulardii (Sb) (Biocodex) and their co-cultures, 299vSb, NCFMSb, PCCSb, LAC343Sb. A blank, which consists of unfermented coffee, was included as a control. Probiotic inoculation was conducted in 200 mL of coffee brews contained within 250-mL glass capped bottles, with inoculum sizes standardised to ˜6.6-7 Log CFU/mL for the probiotic LAB, and ˜6 Log CFU/mL for S. boulardii CNCM-I745. Aliquots of 40 mL or 12 mL of inoculated coffees were then distributed into 50-mL or 15-mL polypropylene centrifuge tubes respectively. Tubes were then kept at 30° C. for 24 h during the fermentation period, and subsequently at either 25° C. or 4° C. during the storage period. Coffees which were fermented for 24 h, and stored after one month at both temperatures were subjected to further analyses (non-volatile measurements). All fermentations were conducted in triplicate batches.

Results

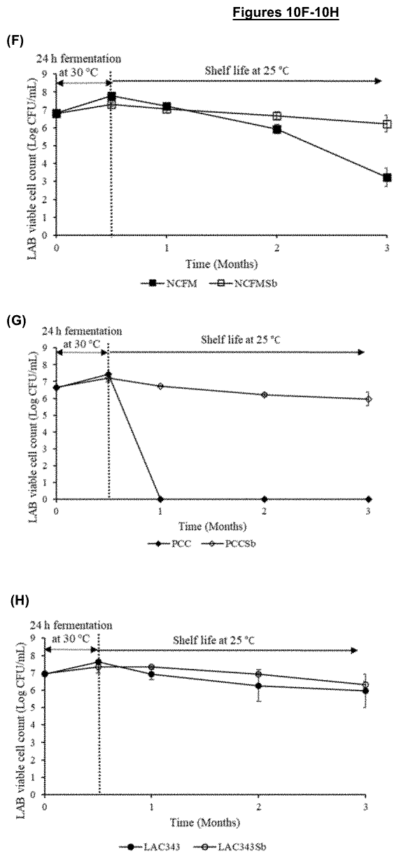

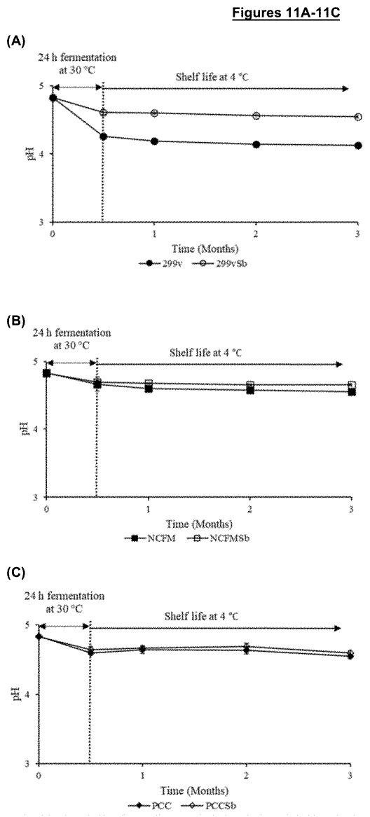

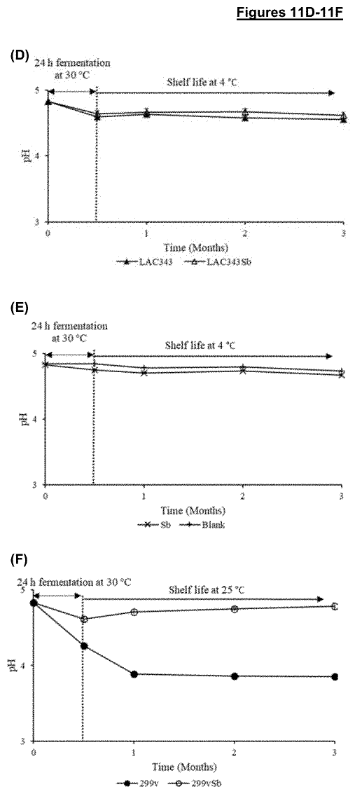

FIG. 10 shows the growth of single and mixed cultures of L. plantarum 299v, L. acidophilus NCFM, L. fermentum PCC, L. gasseri LAC-343, and S. boulardii CNCM-I745 during fermentation in coffee brews and subsequent storage at 4° C. and 25° C.

All probiotics were able to grow to >7 Log CFU/mL, regardless of whether they were singly or co-cultured. This indicates the compatibility of the probiotic yeast, S. boulardii CNCM-I745, with the other four probiotic LAB strains. In addition, excellent growth beyond the recommended dosage of 7 Log CFU/mL suggests that the coffee brew formulation (0.25% glucose and 0.06% Optiwhite®) is applicable to support growth of other probiotic yeast and LAB combinations.

During storage, it was evident that the probiotic yeast was essential to maintain viable probiotic LAB populations in coffee. Regardless of temperature, all co-cultured probiotic LAB maintained viable populations >6-7 Log CFU/mL for at least 3 months. In contrast, single LAB probiotic populations could not be sustained above 6 Log CFU/mL beyond 3 months, with the majority falling below 3 Log CFU/mL.

Interestingly, the viability of single-cultured S. boulardii CNCM-I745 was not significantly different compared to when cultured with other probiotic LAB. This indicates that the probiotic yeast remained unaffected by the presence of probiotic LAB, hence emphasising the excellent compatibility of S. boulardii CNCM-I745 with other probiotic LAB strains.

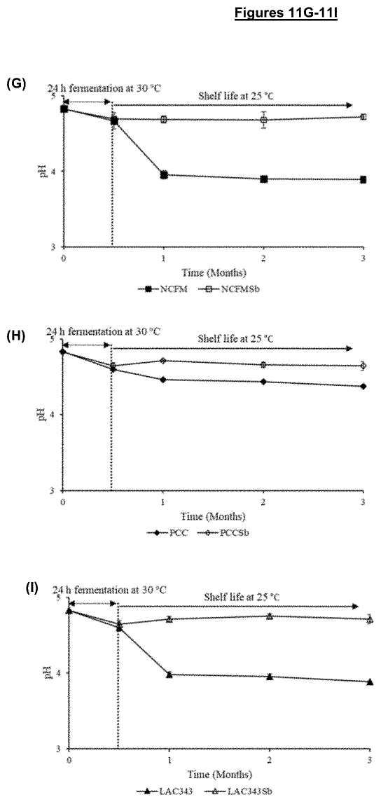

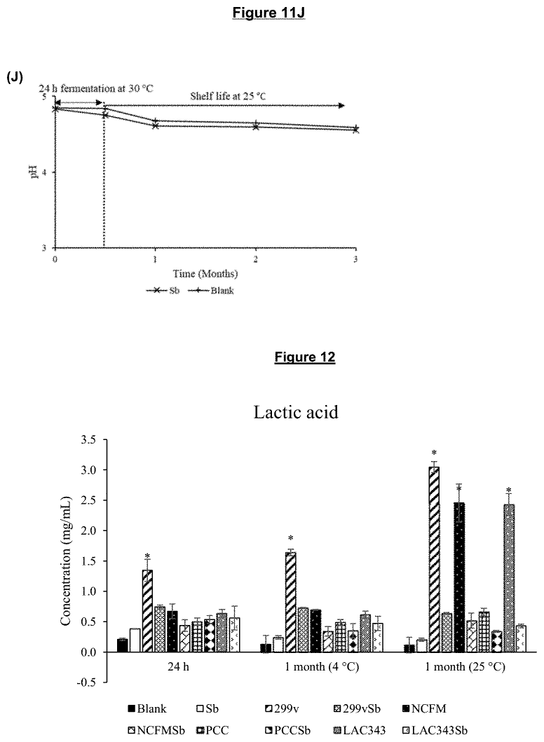

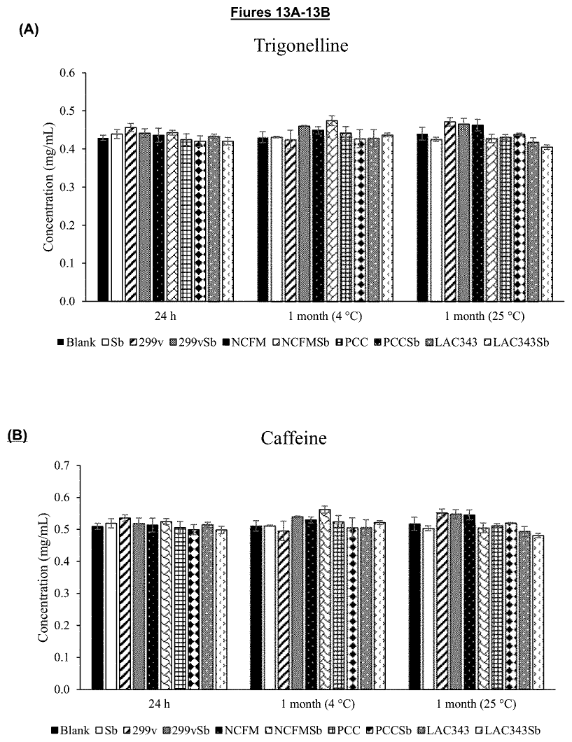

FIGS. 11 and 12 show the pH and lactic acid changes for single and mixed coffee fermentations during fermentation and storage respectively. In general, the degree of pH decrease of single and co-fermented coffee brews was similar after 24 h of fermentation, with the exception of L. plantarum 299v, where its single culture resulted in significantly lower pH compared to the co-culture. Decreases in pH during fermentation are a result of lactic acid production by the probiotic LAB. Lower lactic acid yields and a corresponding higher pH in the co-cultured L. plantarum 299v coffee brew are most likely a result of competition for nutrients (glucose, Optiwhite®) by the yeast. Therefore, if less sour coffee brews are desired after fermentation, co-culturing probiotic LAB with S. boulardii CNCM-I745 is crucial, while maintaining viable probiotic populations.

During cold storage for 3 months, no further changes in pH were observed, attributed to decreased probiotic metabolic activities. However, under ambient conditions, further reductions in pH were observed for single cultures of L. plantarum 299v, L. acidophilus NCFM, and L. gasseri LAC-343, coinciding with lactic acid accumulation (FIG. 12).

An exception was observed for single cultured L. fermentum PCC, which did not see significant declines in pH and lactic acid production during ambient storage. Refrigerated storage may be preferred under such circumstance, to limit excessive pH changes (may produce undesirable sour taste), if single probiotic LAB cultures are used.

In contrast to probiotic LAB single cultures, no further increases in lactic acid were observed for their co-cultured counterparts. Therefore, in the event where cold-supply chains are not available, S. boulardii CNCM-I745 could be effectively used to limit excessive lactic acid production and pH decreases which may impart undesirable sour tastes.

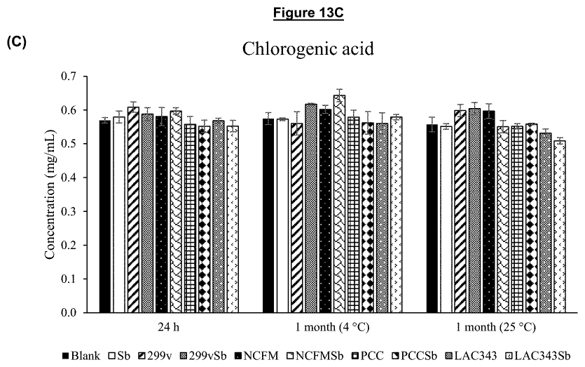

FIG. 13 shows the changes in coffee bioactive components after fermentation and storage. In general, no substantial losses of measured alkaloids (caffeine, trigonelline) and phenolic compounds (chlorogenic acid) were observed. Fermentation and storage of coffee brews did not alter levels of endogenous coffee bioactive constituents, which may indicate that the intrinsic health benefits of coffee are preserved.

Whilst the foregoing description has described exemplary embodiments, it will be understood by those skilled in the technology concerned that many variations may be made without departing from the present invention.

1. A coffee-based beverage comprising probiotics, wherein the probiotics has a live probiotic cell count of ≥6.0 log CFU/mL.

2. The beverage according to claim 1, wherein the probiotics has a live probiotic cell count of ≥7.0 log CFU/mL.

3. The beverage according to claim 1, wherein after 3 months of storage, the probiotics comprised in the beverage has a live probiotic cell count of ≥6.0 log CFU/mL.

4. The beverage according to claim 1, wherein the beverage is a fermented beverage.

5. The beverage according to claim 1, wherein the probiotics comprises: a probiotic bacteria, a probiotic yeast, or a combination thereof.

6. The beverage according to claim 1, wherein the probiotics comprises: lactic acid bacteria, bifidobacteria, Saccharomyces yeast, non-Saccharomyces yeast, or a combination thereof.

7. The beverage according to claim 6, wherein the lactic acid bacteria is selected from the group comprising: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, or a combination thereof.

8. The beverage according to claim 6, wherein the Saccharomyces yeast is selected from the group comprising: Saccharomyces (S.) boulardii, Saccharomyces (S.) cerevisiae, or a combination thereof.

9. The beverage according to claim 6, wherein the probiotics comprises: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, Saccharomyces (S.) boulardii, Saccharomyces (S.) cerevisiae, or a combination thereof.

10. (canceled)

11. (canceled)

12. A method of preparing a coffee-based beverage comprising probiotics having a live cell count of ≥6.0 log CFU/mL, the method comprising:
mixing coffee brew with sugar and an inactivated yeast derivative to form a mixture;
adding probiotics to the mixture to form an inoculated mixture; and
fermenting the inoculated mixture for a pre-determined period of time to form the beverage.

13. The method according to claim 12, wherein the beverage has a live cell count of ≥7.0 log CFU/mL.

14. The method according to claim 12, wherein the sugar is present in the mixture at a concentration of 0.01-10% w/v based on the total volume of the mixture.

15. The method according to claim 12, wherein the inactivated yeast derivative is present in the mixture at a concentration of 0.005-5% w/v based on total volume of the mixture.

16. The method according to claim 12, wherein the probiotics comprises: a probiotic bacteria, a probiotic yeast, or a combination thereof.

17. The method according to claim 12, wherein the probiotics comprises: lactic acid bacteria, bifidobacteria, Saccharomyces yeast, non-Saccharomyces yeast, or a combination thereof.

18. The method according to claim 17, wherein the lactic acid bacteria is selected from the group comprising: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, or a combination thereof.

19. The method according to claim 17, wherein the Saccharomyces yeast is selected from the group comprising: Saccharomyces (S.) boulardii, Saccharomyces (S.) cerevisiae, or a combination thereof

20. The method according to claim 17, wherein the probiotics comprises: Lactobacillus (Lb.) rhamnosus, Lactobacillus (Lb.) paracasei, Lactobacillus (Lb.) plantarum, Lactobacillus (Lb.) acidophilus, Lactobacillus (Lb.) gasseri, Lactobacillus (Lb.) fermentum, Bifidobacterium (B.) lactis, Saccharomyces (S.) boulardii, Saccharomyces (S.) cerevisiae, or a combination thereof.

21. (canceled)

22. The method according to claim 12, wherein the pre-determined period of time is 4-100 hours.

23. The method according to claim 12, wherein the fermenting is at a temperature of 15-45° C.

24. (canceled)

25. (canceled)
